(19) United States
(12) Patent Application Publication
(10) Pub. No.: US 2007/0158022 A1
(43) Pub. Date: Jul. 12, 2007

(54) Method for the production of derived timber product bodies and mouldable derived timber product bodies

(76) Inventors: Wolfgang Heep, Wolterdorf (DE); Wolfgang Kantner, Schwarzenau (AT); Steffen Tobisch, Dresden (DE); Detlef Krug, Dresden (DE)

Correspondence Address: NORRIS MCLAUGHLIN & MARCUS, P.A., P O BOX 1018, SOMERVILLE, NJ, 08876, US

(21) Appl. No.: 10/574,022

(22) PCT Filed: Sep. 15, 2004
(86) PCT No.: PCT/DE04/02074

§ 371 Date: Oct. 4, 2006

(30) Foreign Application Priority Data
Sep. 25, 2003 (DE) 10344926.4

(51) Int. Cl. C09J 5/04

(52) U.S. Cl. 156/317

(57) ABSTRACT

The invention concerns a wood material body, a post-shapeable wood material body and processes for the production of such wood material bodies. The wood material body has one or more layers of strands wetted with a binding agent system. The binding agent system has one or more thermosettingly hardening components and contains a first thermosettingly curing binding agent. The strands wetted with the binding agent system are pressed in a first stage under first temperature and pressure conditions which do not allow complete but only partial curing of the first thermosetting binding agent. The post-shapeable wood material body produced in that way is pressed in a second stage to a predetermined shape under temperature and pressure conditions which allow final curing of the first thermosetting binding agent.

The invention concerns wood material bodies and post-shapeable wood material bodies which have one or more layers of strands wetted with a binding agent system, and processes for the production of wood material bodies of that kind.

The production of wood materials based on veneer, fiber and chip materials has a tradition going back over decades. The consumption of such materials is constantly growing. Those wood materials are produced and used predominantly in the form of panel or board materials.

The areas of use of materials of that kind are extremely diverse. Mention is made here by way of example of the furniture, building and automobile industries. In the furniture industry, panel materials are used for smooth fronts of articles of furniture, side, shelf and rear wall portions in the form in particular of chipboard panels and fiber panels of the most widely differing raw density, which are preferably coated with films, papers or lacquers. By virtue of the actually quite decorative surface of the uncoated OSB panels (OSB=oriented strand board), they are now increasingly used in the form of polished or unpolished panels in shelf construction or for decorative surface design.

A large number of panel materials are used in the building sector, enjoying the properties corresponding to specific demands, for example in the form of groove-and-tongue panels for floors, as ready-made domestic panels or as concrete shuttering panels. Especially plywood panels are sought primarily as load area carrier panels in the automobile industry but are also used extensively in the general building sector and for solutions to specific problems. Both in the shuttering panel sector and also for load area carrier panels OSB panels coated for example with a PF-glue film are also increasingly winning their market share.

For a large number of uses in particular in the furniture sector and also in the automobile industry, shaping of those materials is desired and necessary. Different possible options are known in that respect, depending on the respective starting material involved:

By mechanical working, for example by means of milling, shapes and contours can be subsequently applied to the panel materials, that naturally involving major material losses. MDF panels (MDF=medium density fiberboard) and chipboard panels which are processed in that way and coated with films, papers or lacquers are used in particular for fronts of articles of furniture. If an MDF panel is to be subsequently shaped, that is possible for example by partial slotting of the MDF panel or by deep drawing of suitable fiber panels of low density. With both processes however the shaping options are subject to quite tight limits.

Shaped parts on an HDF basis (HDF=high density fiberboard), produced by a wet process, are achieved by fitting special pressing plates into the multi-platen presses used in that respect. Areas of use are for example door leaves. It will be noted however that the wet process for the production of HDF is to be viewed critically from environmentally relevant points of view.

Post-shaping of HDF panels produced by a wet process is also known, which however is relatively complicated and expensive due to preliminary moistening of the hard fiber panel. The shaping radii which are possible are also to be assessed as being very limited.

Shaped or molded parts on a plywood basis can be obtained for simple shaping operations by applying glue to the veneers and then molding pressing or for more complicated shaping operations by applying resin to very thin veneers with subsequent drying, conditioning and molding pressing. The procedures involved in producing, applying resin to and pressing the veneers is however very complicated and expensive and in addition still involves a great deal of manual work.

As described for example in DE 199 56 765 shaping effects can further be achieved by means of semi-manufactured fiber articles. In that case fiber materials are mixed with binding agents and/or binding fibers, deposited to form a handleable non-woven cloth and later shaped. Areas of use are here in particular shaped parts for vehicle interiors and door leaves. Very good shaping effects are possible in a wide range, with that process. The shaped fiber materials, depending on the respective use involved, are then also coated with films, papers or lacquers.

It will be clear accordingly that chipboard and fiber materials are generally used with a coating, whatever the configuration thereof in detail may be. The reasons for that however involve the surfaces which do not immediately appear decorative.

Decorative surfaces in contrast can be achieved with plywood or shaped parts on a veneer basis. As already set forth, the production of suitable veneers and the selection thereof is very costly. The processing procedures to afford the plywood panel or shaped part are complicated and expensive and involve a great deal of manual work.

Decorative surfaces are also achieved with OSB panels, in particular if they are ground and polished.

For the purposes of gluing the strands for the production of OSB panels, it is possible to use binding agents from the areas of urea-formaldehyde resins (UF), melamine-urea-formaldehyde resins (MUF), melamine-urea-phenol-formaldehyde resins (MUPF), phenol-formaldehyde resins (PF), phenol-urea-formaldehyde resins (PUF), resorcin-phenol-formaldehyde resins (RPF), resorcin-phenol-urea-formaldehyde resins (RPUF), phenol-melamine-formaldehyde resins (PMF), melamine-formaldehyde resins (MF) and polymeric diphenylmethane diisocyanate (PMDI).

The choice of the binding agents used is dependent on the characteristic values to be achieved and is additionally also determined by cost aspects and the technical possibilities or partially inherently specific gluing capacities of the OSB producers.

German laid-open application (DE-OS) No 37 42 652.4 discloses a process for the production of a wood material panel in which wood material particles are glued with a binding agent, the curing of which can be accelerated by means of a hardener, wherein the hardener is contained in gaseous or binary phase with a gaseous carrier agent in microcapsules and the gaseous hardener is liberated with the application of pressure.

DE 42 12 732 A1 discloses a process for the production of a shaped portion with a reinforcing insert, wherein firstly two fiber mats are produced. The reinforcing insert is subsequently arranged between the fiber mats and the whole is then shaped to afford a shaped portion.

In areas of use such as ready-made house building, shuttering panels, motor vehicle load area carrier panels, OSB panel is increasingly coming into competition in particular with chipboard panels and plywoods. In all those uses OSB is employed as a panel material.

In that case contours and shapes are applied to OSB panels exclusively by the known and mentioned mechanical processing processes.

Now the object of the invention is to permit subsequent shaping of semi-finished OSB panels.

That object is attained by a process for the production of wood material bodies which have one or more layers of strands wetted with a binding agent system, wherein the binding agent system has one or more thermosettingly hardening components with a first thermosettingly curing binding agent and a second thermosettingly hardening binding agent which cures at higher temperature and/or pressure conditions than the first thermosetting binding agent, and the strands wetted with the binding agent system are pressed in a first stage under first temperature and pressure conditions which do not allow complete but only partial curing of the first thermosetting binding agent, and a post-shapeable wood material body produced in that way is pressed into a predetermined shape in a second stage under second temperature and pressure conditions which allow final curing of the first and second thermosetting binding agents.

That object is further attained by a post-shapeable wood material body as set forth in claim 12, wherein the binding agent system has a first thermosettingly curing binding agent and a second thermosettingly hardening agent which cures at higher temperature and/or pressure conditions than the first thermosetting binding agent and the first thermosettingly curing binding agent is present in the post-shapeable wood material body not in complete but in only partially cured form.

That object is further attained by a wood material body as set forth in claim 13, wherein the binding agent system contains a combination of a first thermosettingly curing binding agent and a second thermosettingly curing binding agent, wherein the second thermosettingly curing binding agent cures at higher temperatures and pressures than the first thermosettingly curing binding agent, wherein the first and the second thermosettingly hardening binding agent are finally cured at the higher temperatures and pressures or the binding agent system comprises a combination of a first thermosettingly hardened binding agent and a natural adhesive, in particular based on protein- and/or starch-bearing products.

That object is further attained by processes for the production of such wood material bodies as set forth in claim 2 and such post-shapeable wood material bodies as set forth in claim 3.

The shapeability of OSB was always to be considered as critical. The OSB panel comprises thin strands of different but preferably set geometry, which have a markedly greater flexural resistance than fiber materials.

Accordingly the technological processes are very considerably different as between fiber and OSB strand materials. A markedly simpler shaping possibility in respect of fiber materials is clearly apparent to the man skilled in the art. Tests on standard OSB panels showed that such materials are virtually not shapeable. In the shaping presses, the panels break, that is to say the rigid cured chip (strand)/glue composite with in particular very good mechanical properties measured at a right angle to the plane of the panel cannot guarantee the required flexibility and elasticity of the panel.

Surprisingly to the men skilled in the art however it was possible to establish that the production of post-shapeable OSB is possible by the combination of two or more binding agents which contain one or more thermosettingly hardening components, wherein the second binding agent cures at higher temperature and/or pressure conditions than the first binding agent, and a special OSB production technology.

For that purpose it is necessary to produce a semi-finished OSB article, the properties of which are only determined by the fact that the semi-finished article is sufficiently dimensionally stable for subsequent processing such as for example cutting to size and transport and storage processes.

In accordance with the invention that requirement is attained in that a semi-finished article is produced in which the first binding agent or the binding agents used are not or are only partially cured.

A plurality of advantages are achieved by the invention:

The invention permits subsequent shaping of semi-finished OSB articles while very substantially retaining the decorative surfaces and the special mechanical properties of the OSB panels, whereby further and broader uses are opened up for that still relatively new material.

The high levels of investment in OSB equipment technology of leading wood material manufacturers means that the production of OSB panels is possible very economically. That equipment technology can be used for implementing the process according to the invention so that cost advantages are enjoyed.

The production of single-layer or three-layer OSB panels gives rise to no problems, which basically affords a further advantage as a basic material for shaped parts of OSB. In that respect those panels can be additionally influenced in a specifically targeted fashion in regard to their properties by the wood material used, oriented or non-oriented scattering of the strands and finally also by the strand configuration (length, width and thickness).

Advantageous configurations of the invention are identified in the appendant claims.

Investigations have shown that good working properties in respect of the semi-finished OSB as well as a high level of stability in respect of the post-shaped OSB product are achieved if the pressing operation in the first stage is effected at a temperature of less than 120° C. and the pressing operation in the second stage is effected at a temperature of greater than 150° C. A further improvement can be achieved if the operation of pressing the strands in the first stage is effected at a pressure which is at least 10 bars lower than in the second stage.

In accordance with the invention, besides the first thermosettingly hardening binding agent, the binding agent system contains a second thermosettingly hardening binding agent which cures at higher temperature and/or pressure conditions than the first thermosetting binding agent. The second thermosettingly curing binding agent cures only in the post-shaping operation and additionally increases the stability of the end product.

In accordance with a further preferred embodiment of the invention, besides the first thermosettingly hardening binding agent, the binding agent system contains a natural adhesive, in particular based on protein- and/or starch-bearing products. That natural adhesive enhances the stability of the semi-finished OSB article.

Further advantages can be achieved by the binding agent system being supplemented by isocyanate-based adhesives.

Processing advantages can be achieved by the combination of powder and fluid binding agents.

In order better to understand the invention the invention is described in detail hereinafter by means of a number of embodiments by way of example.

Conventional strands, for example pine wood or deciduous wood strands or a mixture thereof of a length of about 100 to 145 mm are coated with a binding agent system for example in a drum mixer.

In order to produce a semi-finished OSB article whose properties are determined by the fact that the semi-finished article is sufficiently dimensionally stable for subsequent processing such as for example cutting to size and transport and storage processes and is further also post-shapeable, in that situation a binding agent system is used which is not or only partially cured in the production of the semi-finished OSB article.

That can be achieved by partial activation of thermosetting binding agents from the range of UF, MUF, MUPF, PE, PUF, RPF, RPUF, PMF, MF and/or by utilising the (cold) adhesiveness of natural binding agents based on for example protein-bearing or starch-bearing products. Optionally the bonding of the semi-finished article can also be supported by small amounts of isocyanate binding agents.

It is only in the final pressing operation at the user that shaping and definitive hardening of the actual thermosetting binding agent or agents takes place.

The production of post-shaped OSB therefore takes place in two steps:

a) production of the semi-manufactured article, and

b) shaping.

Production of the semi-manufactured article can be effected both on OSB multi-platen presses and also on OSB installations with continuous presses.

That option is of high economic interest as it means that no new investment in standard installation press technology requiring modification is necessary for manufacture of the semi-manufactured OSB panel.

The operation of gluing the strands is effected with one or more of the above-specified binding agents.

Production of the semi-manufactured article is preferably effected at a pressing temperature <120° C. so as to ensure that the binding agent or agents is or are only partially activated as viewed over the panel cross-section. One or more binding agents which can be activated for the shaping pressing operation are then also contained in the semi-manufactured article produced in that way.

For additionally protecting the surfaces from adhesion tendencies on the part of the semi-manufactured article the use of internal separation agents and/or external separation agents applied to the pressing belts or the strand molding is possible and partially necessary.

The aim is to produce a handleable, mechanically workable semi-manufactured article. After being suitably cut to size the semi-manufactured article can be stored several weeks or months before it is used on the part of the customer for shaping.

That semi-manufactured article is then shaped and subjected to final pressing in a shaping press under elevated temperature and pressure. In that shaping stage the binding agent or agents used are activated under pressure and temperature and caused to flow. In that process the binding agent/agents are then definitively cured, whereby the appropriate dimensional stability and mechanical properties are imparted to the shaped article.

For production of the semi-manufactured article it is possible to use binding agents from the classes of binding agents which are used as standard for the production of OSB such as unmodified or modified UF, MUF; MUPF, PF, PUF, RPF, RPUF, PMF, MF resins both in liquid and also powder form. Combinations with PMDI binding agents are also possible.

The specified types of binding agents can be supplemented by adhesives on a natural basis such as protein- and/or starch-based adhesives.

### EXAMPLE A

The gluing operation is effected with 8% FH/bone-dry of an UF-glue and 15% FH/bone-dry of a PF-powder resin. Production of the semi-manufactured article is effected at 110° C. and under a specific pressing pressure of about 10-20 bars in a standard OSB press so that the UF-resin experiences initial hardening and jointly with the PF powder resin by fusion joining thereof gives a handleable semi-manufactured article after leaving the press. The semi-manufactured article is then definitively cured in a shaping press at about 200° C. and under a pressure of about 35 bars.

### EXAMPLE B

The gluing operation is effected with 8% FH/bone-dry of an UF-glue, 15% FH/bone-dry of a liquid PF resin and 5% solid substance/bone-dry of a wheat protein-bearing adhesive. Production of the semi-manufactured article is effected at 110° C. in a standard OSB press so that the PF liquid resin only experiences initial hardening and affords a handleable semi-finished article. The semi-finished articles produced in that way are subjected to definitive curing in a shaping press at elevated temperature of about 200° C. and under an elevated pressure of about 45 bars.

Shaping of OSS panels has become possible with the semi-manufactured articles produced in accordance with the invention, which hitherto was considered to be impossible by virtue of the specific structure and the specific properties of OSB panels. That ultimately opens up a new market for OSB panels, which should be fundamental to future product and market development of OSB panels.

1. A process for the production of wood material bodies which have one or more layers of strands wetted with a binding agent system,
characterised in that the binding agent system has one or more thermosettingly hardening components with a first thermosettingly curing binding agent and a second thermosettingly hardening binding agent which cures at least one of higher temperature and higher pressure conditions than the first thermosetting binding agent, and the strands wetted with the binding agent system are pressed in a first stage under first temperature and pressure conditions which do not allow complete but only partial curing of the first thermosetting binding agent, and a post-shapeable wood material body produced in that way is pressed into a predetermined shape in a second stage under second temperature and pressure conditions which allow final curing of the first and second thermosetting binding agents.

2. A process for the production of post-shapeable wood material bodies which have one or more layers of strands wetted with a binding agent system,
characterised in that
the binding agent system contains a first thermosettingly curing binding agent and a second thermosettingly hardening binding agent which cures at least one of higher temperature and higher pressure conditions than the first thermosetting binding agent, and the strands wetted with the binding agent system are pressed under temperature and pressure conditions which do not allow complete but only partial curing of the first thermosetting binding agent.

3. A process for the production of wood material bodies which have one or more layers of strands wetted with a binding agent system,
characterised in that
a post-shapeable wood material body with a binding agent system which contains a first thermosettingly curing binding agent and a second thermosettingly hardening binding agent which cures at least one of higher temperature and higher pressure conditions than the first thermosetting binding agent, wherein the first thermosettingly curing binding agent is present in the post-shapeable wood material body not in complete but in only partially cured form is pressed in a second stage to a predetermined shape under temperature and pressure conditions which allow final curing of the first and second thermosetting binding agents.

4. A process as set forth in claim 1,
characterised in that the thermosettingly hardening binding agent system is modified by a third binding agent comprising a natural adhesive.

5. A process as set forth in claim 1,
characterised in that at least one of the first and the second thermosettingly hardening binding agents comprises the group of UF, MUF, MUPF, PF, PUF, RPF, RPUF, PMF and MF resins, wherein the central layer strands and the cover layer strands are glued with at least one of the same and different binding agents from that group.

6. A process as set forth in claim 1
characterised in that the binding agent system is supplemented by isocyanate-based adhesives.

7. A process as set forth in claim 1
characterised in that pressing of the strands in the first stage is effected at a pressure which is at least 10 bars lower than in the second stage.

8. A process as set forth in claim 1
characterised in that pressing in the first stage is effected at a temperature of less than 120° C. and pressing in the second stage is effected at a temperature of greater than 150° C.

9. A process as set forth in claim 1,
characterised in that the binding agent system has a combination of binding agents in powder form.

10. A process as set forth in claim 1,
characterised in that the binding agent system has a combination of liquid binding agents.

11. A process as set forth in claim 1,
characterised in that at least one of (i) the first binding agent is liquid and the second binding agent is in powder form and (ii) or the second binding agent is liquid and the first binding agent is in powder form.

12. A post-shapeable wood material body which has one or more layers of strands wetted with a binding agent system,
characterised in that
the binding agent system has a first thermosettingly curing binding agent and a second thermosettingly hardening agent which cures at least one of higher temperature and higher pressure conditions than the first thermosetting binding agent and the first thermosettingly curing binding agent is present in the post-shapeable wood material body not in complete but in only partially cured form.

13. A wood material body which having one or more layers of strands wetted with a binding agent system,
characterised in that
the binding agent system contains a combination of a first thermosettingly curing binding agent and a second thermosettingly curing binding agent, wherein the second thermosettingly curing binding agent cures at higher temperatures and pressures than the first thermosettingly curing binding agent, wherein the first and the second thermosettingly hardening binding agent are finally cured at the higher temperatures and pressures.

14. The process of claim 4, wherein the natural adhesive includes at least one of a protein product and a starch-bearing product.

15. The process of claim 13, wherein the binding agent system comprises a combination of a first thermosettingly hardened binding agent and a natural adhesive.

16. The process of claim 15, wherein the natural adhesive includes at least one of a protein product and a starch-bearing product.
